(19) United States
(12) Patent Application Publication
(10) Pub. No.: US 2013/0319793 A1
(43) Pub. Date: Dec. 5, 2013

(54) Fall Arrest Apparatus

(71) Applicant: Paul Stibilj, Glenella (AU)

(72) Inventor: Paul Stibilj, Glenella (AU)

(73) Assignee: SAS Safety Systems Holdings Pty Ltd as Trustee for the SAS Safety Systems Holdings Unit Trust, Burleigh Waters (AU)

(21) Appl. No.: 13/985,648

(22) PCT Filed: Feb. 17, 2012
(86) PCT No.: PCT/AU2012/000149

§ 371 Date: Aug. 15, 2013

(30) Foreign Application Priority Data
Feb. 17, 2011 (AU) 2011900531

(51) Int. Cl. A62B 35/00

(52) U.S. Cl. CPC A62B 35/0012; A62B 35/0018
USPC 182/3

(57) ABSTRACT

A fall arrest apparatus has a body harness having a backrest and a seat and capable of being worn by a user so that the backrest extends from a rear shoulder region to a rear hip region of the user while the seat extends from about the rear hip region to a rear thigh region of the user. A suspension harness is configured for connection to the body harness at a front shoulder region and at a front thigh region, such mat when the user is suspended from the suspension harness in the body harness, the user is reclined in the body harness with a weight of the user being distributed across the backrest and seat assemblies.

### FIELD OF THE INVENTION

This invention relates to a fall arrest apparatus. The invention also relates to a harness for use with a fall arrest apparatus and to an accessory for a fall arrest system or apparatus.

### BACKGROUND TO THE INVENTION

Fall arrest systems are currently used and are compulsory in many jurisdictions. Currently, many fall arrest systems have a harness that supports the user either under the shoulders or around the thighs or in both locations.

There are dangers associated with supporting the user in such a manner while the user is suspended. The danger is as a result of what is known as “harness-induced death” or “suspension trauma” or “orthostatic intolerance”. These are brought about by the restriction of blood flow from the legs of the user due to the manner in which the user is suspended. It has been documented that a suspension time of as little as five minutes can be life-threatening. The restriction of the blood flow results in a pooling of the blood in the legs which reduces the return blood flow to the heart. The brain, kidneys and other organs are then deprived of blood and oxygen which can lead to lack of consciousness, serious injury and then death.

There are three factors which contribute to this dangerous situation. Firstly, the user is suspended in such a manner that the legs dangle. Secondly, the straps of the safety harness constrict the thighs resulting in the reduced blood flow. Thirdly, the safety harness retains the user in an upright position regardless of loss of consciousness. It is this third factor that can result in death.

Rescue is required to be carried out extremely carefully. For example, if the user is moved quickly into a horizontal position, which would be a natural reaction of a rescuer, a large volume of deoxygenated blood moves to the heart which may then be unable to cope resulting in cardiac arrest.

### SUMMARY OF THE INVENTION

According to a first aspect of the invention, there is provided a fall arrest apparatus that comprises

a body harness having a backrest and a seat and capable of being worn by a user so that the backrest extends from a rear shoulder region to a rear hip region of the user while the seat extends from about the rear hip region to a rear thigh region of the user; and

a suspension harness configured for connection to the body harness at a front shoulder region and at a front thigh region, such that when the user is suspended from the suspension harness in the body harness, the user is reclined in the body harness with a weight of the user being distributed across the backrest and seat assemblies.

The body harness may include a waist band for securing about a user's waist and a buckle so that the waist band can be secured to and released from a user. The buckle may be adjustable so that the waist band can be adjusted to suit different users.

The backrest and seat may include a pair of back straps arranged on the waist band. The back straps may be configured to extend from a region between knees and buttocks of the user over the shoulders of the user.

The seat may include a thigh support or band that is configured to extend across rear thigh portions of the user. Operatively lower ends of the back straps may be fastened to the thigh band. Leg bands may be fastened to the thigh band and may be configured to be fastened about respective legs of the user. The leg bands may be configured to be fastened about the respective legs of the user above the user's knee. The leg bands may be adjustable to suit different users.

The apparatus includes a neck brace. The neck brace may have shoulder members that are shaped so that the brace can fit over the user's shoulders. A neck support member may be interposed between the shoulder members and shaped to cradle the user's neck. The back straps may be threaded through respective shoulder members.

Connectors may be fastened to respective operatively upper ends of the back straps. The connectors may be configured for sliding engagement with further straps, so allowing said upper straps to be secured to further straps and constrained to sliding movement along said upper straps. Thus, the connectors may each define a pair of slots, one for attachment of the associated back strap and the other for receiving said further straps.

The apparatus may include two support straps connected at one end to respective leg bands. Each support strap may be received through a length adjustment mechanism and through a respective one of the connectors so that the support straps can slide with respect to the connectors, the extent of sliding being limited by a position of the adjustment mechanisms. The length adjustment mechanisms may be in the form of tensioners.

It will thus be appreciated that ends of the back straps may be connected to the support straps while being capable of limited displacement relative to the support straps along a portion of the length of the support straps. A connecting member such as a D-ring may be fastened to each opposite end of the support straps for connection to a safety support system. Thus, if the user falls, the support straps move into a vertical position, pulling the thighs upwardly and tilting the user back. Said tilting or recumbency may be determined by the position of the length adjustment mechanism against which the connectors bear when the user is recumbent. Thus, recumbency of the user is adjustable.

The support straps may be stowed when not in use. The apparatus may include an attachment mechanism for attaching the support straps to a suitable part of the apparatus in a stowed condition while remaining connected to the safety support system, the attachment mechanism being configured to release the support straps if the user falls.

In one example, ends of the support straps and the neck brace may have complementary attachment mechanisms so that the ends can be attached to the neck brace with the connecting members attached to the safety support system. The attachment mechanisms may be configured to detach if the user falls so that the support straps can assume the vertical orientation described above. The attachment mechanisms may be in the form of tongue and slot devices or mechanisms or similar devices.

The backrest and seat may also include a foraminous material or mesh secured between the back straps to overlie back and seat areas of the user. The mesh may be formed from lengths or woven material, said material being of the type used for safety equipment for climbing, for example.

According to a second aspect of the invention, there is provided a fall arrest apparatus that comprises

a body harness having a weight supporting arrangement that includes a back support, the body harness being configured for fastening to a user such that the back support is positioned over at least a portion of the user's back; and

a suspension harness configured for connection to a fall arrest system, the suspension harness including a seat and being connected to the back support such that when the user is suspended, a user is seated in the body and suspension harnesses, the suspension harness being adjustable to alter an angle at which the user is reclined in said seated position.

The body harness may include a pair of spaced shoulder straps that extend from the back support to be positioned over the shoulders of a user. The shoulder straps may be adjustable to suit different users. The back support may be fastened between the shoulder straps.

A waist strap may be fastened to the shoulder straps to extend about a waist of the user. The waist strap may also be adjustable to suit different users. The waist strap may be fastened to the shoulder straps both behind the user and in front of the user.

A chest strap may be fastened between the shoulder straps to extend across a chest of the user. The chest strap may also be adjustable to suit different users.

The seat may be saddle-shaped with a broader portion towards the back and a narrower portion towards the front to be received between the user's legs.

A pair of thigh straps may be fast with the seat to be passed over the user's thighs to ensure proper location of the seat. Each thigh strap may be adjustable to suit different users.

The suspension harness may include a spreader bar. A connector may be fast with the spreader bar so that the spreader bar can be connected to the existing fall arrest system. The connector may be in the form of an eye connector to permit a locking snap hook fastener or the like to be fastened to the eye connector.

Each of a pair of back straps may be connected to a respective end of the spreader bar at one end and to a respective shoulder strap at an opposite end. Each back strap may be connected to the shoulder strap to be positioned behind the user's head.

Each back strap may be connected at an operatively lower end to the seat. Each of a pair of front straps may be connected to a respective end of the spreader bar at one end and to the narrower portion of the seat at an opposite end. A Y-shaped connector may be connected to each of the front straps and to the narrower portion of the seat.

Both the back straps and the front straps may be adjustable. Thus, an angle of inclination of the user when seated in the apparatus can be adjusted by adjusting the lengths of the back and front straps.

Instead of being saddle-shaped, the seat may be shaped to correspond with the user's buttocks and rear upper thigh area. The seat may be of webbing, of the type which is usually used for harnesses and the like for high-level activities such as mountaineering and rescue work and of a foraminous material such as a mesh supported by the webbing.

The back support may also be of webbing and a foraminous material such as a mesh. In one embodiment, the back support and the seat may define a single sling-like structure.

According to a third aspect of the invention, there is provided a body harness for a fall arrest apparatus, the body harness comprising

a support member having a seat and a backrest;

a hanger capable of being connected to a fall arrest system;

at least one back strap for connecting the backrest to the hanger; and

at least one front strap for connecting the seat to the hanger, such that, in use, the user is positioned between the front and back straps, the front and back straps being adjustable such that an angle of inclination of the user, when supported, can be adjusted.

The support member may be of webbing and a foraminous material such as mesh. The material of the webbing and the mesh may be of the type used for harnesses and the like for high-level activities such as mountaineering and rescue work. The webbing material may be foraminous to enhance comfort.

The hanger may include a spreader bar. An eye connector may be fast with the spreader bar and configured so that a snap hook fastener or the like can be fastened to the hanger.

The body harness may include a pair of back straps, each strap connected at one end to a respective end of the spreader bar and at an opposite end to a respective side of the backrest.

The seat of the support member may be bifurcated to define a pair of leg support portions. A pair of thigh straps may be connected to each leg support portion so that a user's leg can be positioned between each pair of thigh straps.

The body harness may include a pair of front straps, each strap connected at one end to a respective end of the spreader bar and at an opposite end to a respective leg support portion. Each front strap may be connected to a respective pair of thigh straps.

The body harness may include a waist strap that is connected to the backrest and configured for location about a user's waist. The waist strap may be adjustable to suit different users.

According to a fourth aspect of the invention, there is provided an accessory for a fall arrest apparatus. the accessory comprising

a weight supporting arrangement that defines a back support and a seat and is configured to support a back and seat area of a user, the weight supporting arrangement being capable of being connected to an existing fall arrest harness; and

a suspension assembly configured for connection to an existing fall arrest system and to the weight supporting arrangement such that, in use, the weight of the user is supported by the weight supporting arrangement.

It is to be appreciated that the components of the various aspects described above can be combined in many different ways, if necessary. For example, the inventor envisages that a fall arrest apparatus could be assembled from components described in different aspects.

The invention is now described, by way of example, with reference to the accompanying drawings. The following description is provided for illustrative purposes only so that a reader has sufficient information to perform embodiments of the invention. As such, it is not intended to narrow the scope of the preceding paragraphs or the appended claims.

### BRIEF DESCRIPTION OF THE DRAWINGS

FIG. 1 shows a three-dimensional view of an embodiment of a fall arrest apparatus, in accordance with the invention.

FIG. 2 shows a three-dimensional view of a body harness of the fall arrest apparatus of FIG. 1.

FIG. 3 shows a three-dimensional view of a suspension harness of the fall arrest apparatus of FIG. 1 connected to a seat.

FIG. 4 shows a front view of a user wearing the fall arrest apparatus of FIG. 1.

FIG. 5 shows a rear view of the user wearing the fall arrest apparatus of FIG. 1.

FIG. 6 shows a schematic view of the user suspended by the fall arrest apparatus of FIG. 1.

FIG. 7 shows a rear view of a user wearing a further embodiment of a fall arrest apparatus, in accordance with the invention.

FIG. 8 shows a front view of a user wearing the embodiment of FIG. 7.

FIG. 9 shows a side view of a user suspended by the apparatus of FIG. 7.

FIG. 10 shows a three-dimensional front view of a head support for use with the apparatus of FIG. 1 or FIG. 7.

FIG. 11 shows a three-dimensional rear view of the head support of FIG. 10.

FIG. 12 shows a front view of the head support of FIG. 10.

FIG. 13 shows a side view of the head support of FIG. 10.

FIG. 14 shows a rear view of the head support of FIG. 10.

FIG. 15 shows a three-dimensional view of a fall arrest harness, in accordance with the invention.

FIG. 16 shows an embodiment of a fall arrest apparatus, in accordance with the invention, in use.

FIG. 17 shows a rear view of the apparatus of FIG. 16.

FIG. 18 shows a front view of the apparatus of FIG. 16.

FIG. 19 shows a connecting arrangement for connecting the apparatus of FIG. 16 to an existing fall arrest harness.

FIG. 20 shows a connector of the connecting arrangement of FIG. 19.

FIG. 21 shows a rear view of a user wearing an embodiment of a fall arrest apparatus, in accordance with the invention.

FIG. 22 shows a front view of the user wearing the embodiment of FIG. 21.

FIG. 23 shows a support strap of the embodiment of FIG. 21 in a stowed condition.

FIG. 24 shows the support strap of FIG. 23 in a released condition.

FIG. 25 shows a back strap and the support strap of the embodiment of FIG. 21.

FIG. 26 shows a thigh strap and the support strap of the embodiment of FIG. 21.

FIG. 27 shows the fall arrest apparatus of FIG. 21 in a deployed condition.

FIG. 28 shows detail of a manner in which a support strap is connected to a back strap.

FIG. 29 shows detail of a neck brace.

FIG. 30 shows detail of a tongue and slot mechanism for stowing the support straps.

FIG. 31 shows detail of the manner in which a support strap is connected to a leg band.

### DETAILED DESCRIPTION OF THE DRAWINGS

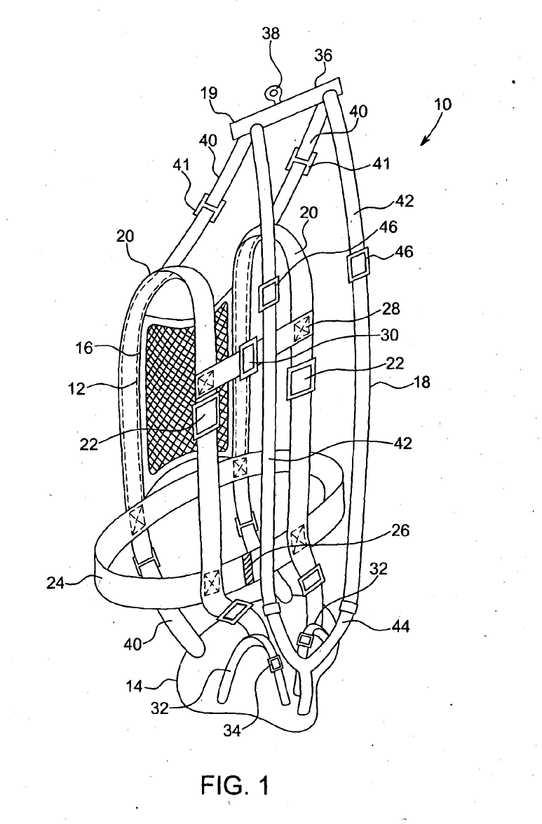

In FIG. 1, reference numeral 10 generally indicates an embodiment of a fall arrest apparatus, in accordance with the invention.

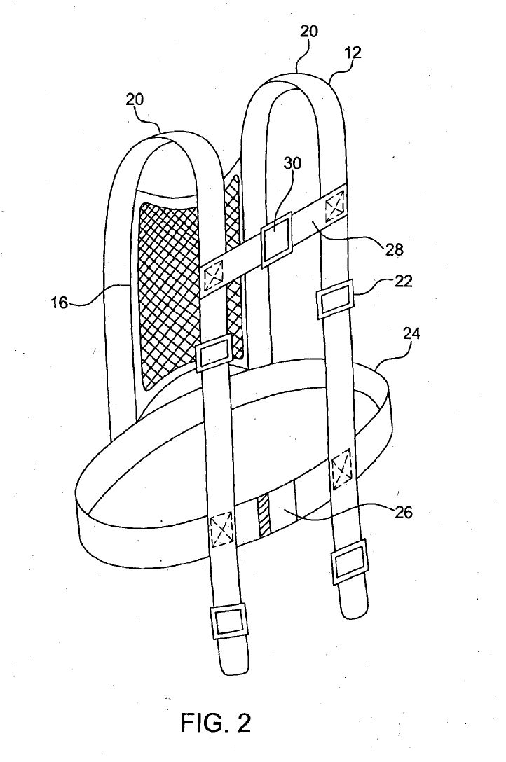

The fall arrest apparatus 10 includes a body harness 12 (see FIG. 2 for a discrete view). A backrest or back support 16 is arranged on the body harness. The body harness 12 is configured for fastening to a user such that the back support 16 is positioned over at least a portion of the user's back.

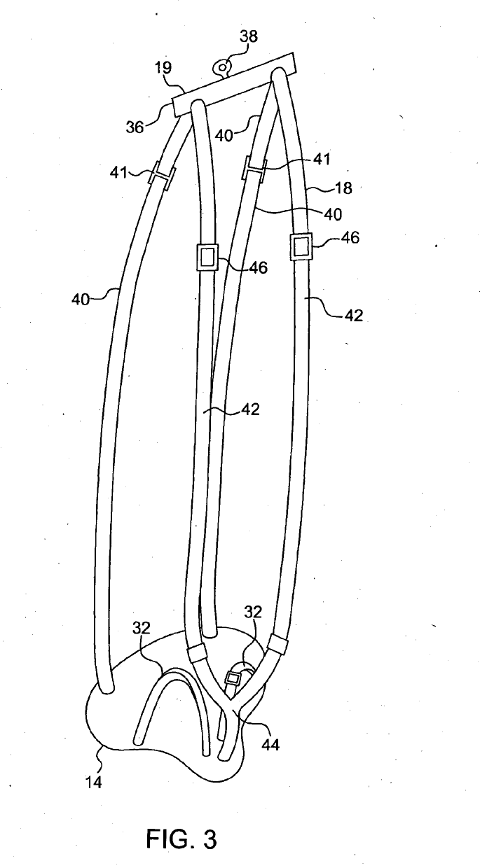

The apparatus 10 also includes a suspension harness 18 (see FIG. 3 for a discrete view). The suspension harness 18 is configured for connection to a fall arrest system. A seat 14 is attached to the harness 18 and is connected to the back support 16 so that when the user is suspended, the user is seated on the seat 14 in the body harness 12. The harness 18 is adjustable to alter an angle at which the user is reclined in the seated position. The harness 18 is adjustable so that the user can be at any position between a substantially upright seated position and a reclined or recumbent position.

The body harness 12 includes a pair of spaced shoulder straps 20 that are configured to extend from a rear waist area of a user, over shoulders of the user and to a front waist area of the user. A waist strap 24 is fast with the shoulder straps 20 to extend about a waist of the user. The waist strap 24 is also adjustable to suit different users. The waist strap 24 is fastened to the shoulder straps 20 both behind the user and in front of the user. The waist strap 24 can also be adjustable by way of a buckle and loop arrangement 26.

The shoulder straps 20 are adjustable to suit different users. The back support 16 is fastened between the shoulder straps 20. The shoulder straps 20 are of a material which is usually used with safety equipment. Thus, the shoulder straps 20 can be of a webbing material or any other suitable material with sufficient load-bearing capacity. An example of such material would be similar to the material used for high-level activities such as mountaineering and rescue work. Adjustment of the shoulder straps 20 can be by way of buckle and loop arrangements 22 similar to those conventionally used for adjusting strap length.

A chest strap 28 is fast between the shoulder straps 20 to extend across a chest of the user. The chest strap 28 is also adjustable to suit different users. Adjustment of the chest strap 28 can be by way of a buckle and loop arrangement 30.

The seat 14 is saddle-shaped with a broader portion towards the back and a narrower portion towards the front to be received between the user's legs.

A pair of thigh straps 32 is fast with the seat 14 to be passed over the user's thighs to ensure proper location of the seat 14. Each thigh strap 32 is also adjustable by way of a buckle and loop arrangement 34.

The suspension harness 18 includes a hanger 19 for connecting the suspension harness 18 to a fall arrest system. The hanger 19 includes a spreader bar 36. An eye connector 38 is fast with the spreader bar 36 and is configured to permit a locking snap hook fastener or the like to be fastened to the eye connector 38 as shown in FIG. 6.

Each of a pair of back straps 40 is connected to a respective end of the spreader bar 36 at one end and to a back side of the seat 14 at an opposite end. Each back strap 40 is connected to be positioned behind the user's head. A length of each back strap 40 is adjustable by way of a buckle and loop arrangement 41. Each back strap 40 is also stitched, or otherwise fastened, to each shoulder strap 20.

Each of a pair of front straps 42 is connected to a respective end of the spreader bar 36 at one end and to the narrower portion of the seat 14. An opposite end of each front strap 42 is connected to a Y-shaped connector 44 which, in turn, is connected to the narrower portion of the seat 14. Each front strap 42 is adjustable in length by way of a buckle and loop arrangement 46.

The front and back straps 42, 40 are of a suitable, load-bearing webbing or other material generally used for supporting personnel during various activities such as climbing, high-level maintenance work etc.

It is to be appreciated that when the user is suspended in the apparatus 10, the weight of the user is distributed across the back support 16 and the seat 14. The extent to which the back support 16 or the seat 14 bears the weight is dependent upon the angle of inclination or the extent of recumbency of the user. The extent of recumbency is adjustable by adjusting the relative lengths of the front and back straps 42, 40 with respect to each other. Thus, lengthening the back straps 40 with respect to the front straps 42 increases the recumbency of the user while shortening the back straps 40 with respect to the front straps 42 tends to position the user in a seated condition.

The back support 16 is a panel of mesh secured between the shoulder straps 20. The mesh is of a material of the type suitable for safety equipment used for climbing, high altitude maintenance work etc. In this example, the webbing is foraminous to allow air circulation and to provide a level of comfort to the user.

The seat 14 is also in the form of a panel of suitable material. This can be a leather material or a synthetic leather-like material. Furthermore, the seat panel can be padded for comfort, if necessary.

In FIG. 6, the user is shown supported in the apparatus 10 while being suspended from an existing fall arrest system. As can be seen, the user is in a seated condition with both the seat area and the back of the user being supported so that the load is distributed. In that position, there is little or no constriction of any of the limbs thus allowing normal blood flow. The inventor believes that the user can be supported in that position for a significant length of time while he or she awaits rescue. This is in contrast to existing fall arrest systems which tend to constrict the body, either under the arms or around the thighs or both.

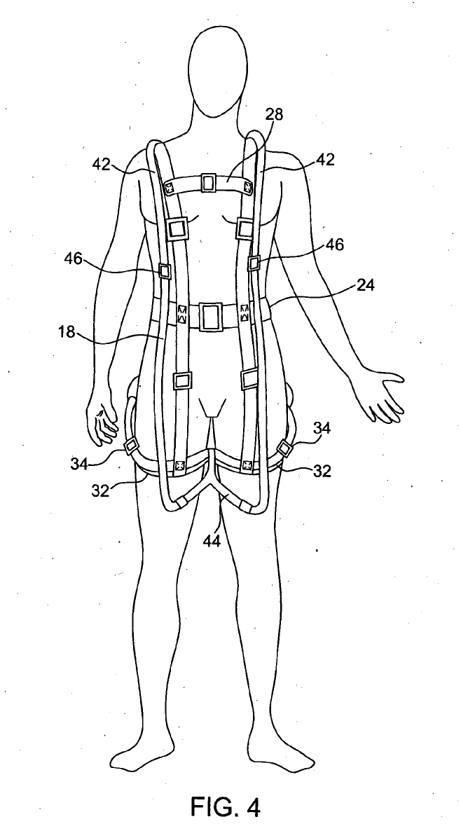

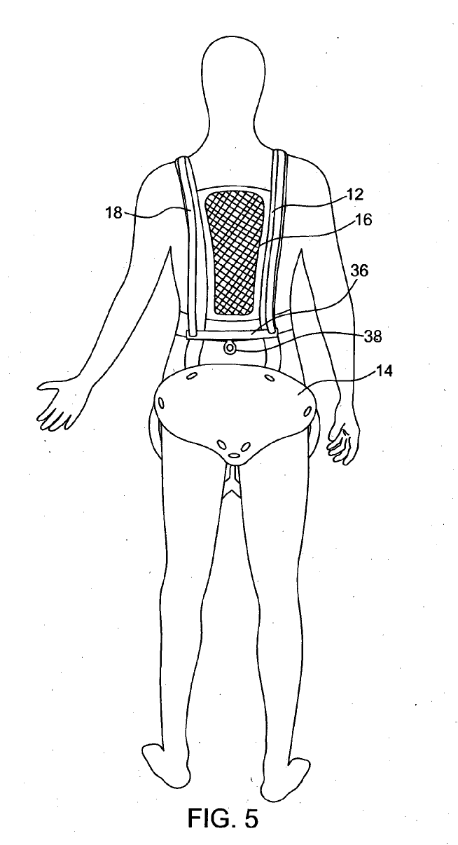

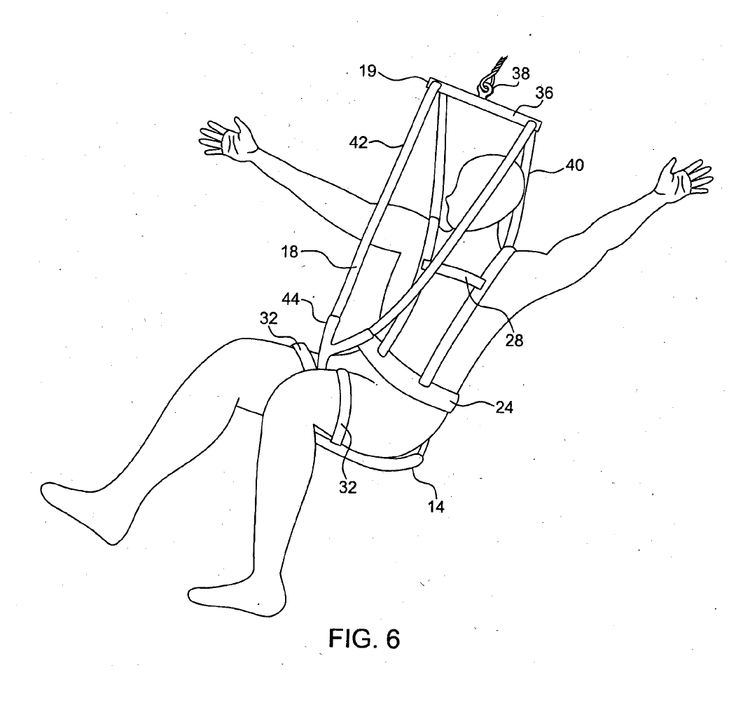

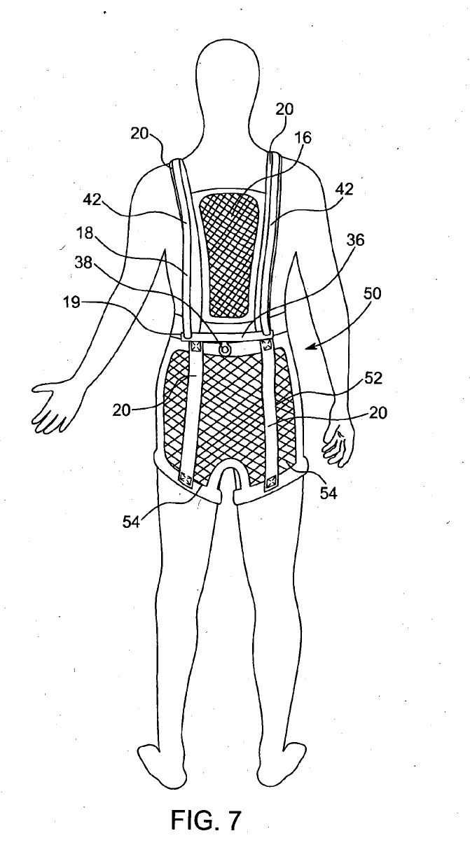

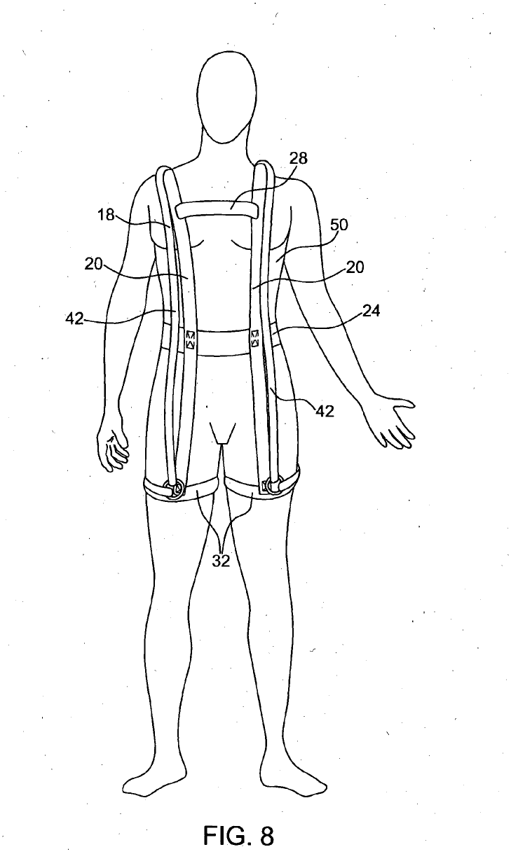

In FIGS. 7 and 8, reference numeral 50 generally indicates a further embodiment of a fall arrest apparatus, in accordance with the invention. With reference to FIGS. 1 to 6, like reference numerals refer to like parts, unless

Instead of the saddle-shaped seat 14, the fall arrest apparatus 50 has a seat 52 that is shaped to correspond with the user's seat area and upper rear thigh portions. To this end, the seat 52 defines a pair of leg portions 54. The shoulder straps 20 extend from an operatively lower edge of respective leg portions 54, over the user's shoulders, to each thigh strap 32.

In this embodiment, the seat 54 is of a foraminous material or mesh to facilitate air circulation and thus enhance comfort for the user.

In the above embodiments, the suspension harness 18 is temporarily fastened to the shoulder straps 20 as shown in FIG. 7, with the front straps 42 and the back straps 40 overlying the shoulder straps 20. This keeps the suspension harness 18 safely stowed while the user is working so that the harness 18 does not interfere with the user. The temporary fastening can take a number of different forms. For example, the temporary fastening can be in the form of complementary hook-and-loop (such as Velcro®) patches sewn onto the back straps 40 and the shoulder straps 20 of the body harness 12. It will readily be appreciated that other forms of temporary fastening can be used such as stitching or press studs. The requirement with the temporary fastening is that it be capable of release when the user's weight is born by the spreader bar 36.

In this embodiment, the temporary fastening is sewn or otherwise fastened to the straps 20 such that the spreader bar 36 is stowed against the user's back. However, it will readily be appreciated that in those situations where the user is working in an environment in which the support structure is faced by the user, such as would be found when working on towers and the like, the temporary fastening can be arranged on the shoulder straps 20 so that the spreader bar 36 is stowed against a user's front. Thus, should the user fall, the spreader bar 36 moves away from the user into its operative position.

In FIG. 9 there is shown a user in a seated condition suspended in the apparatus 50. As with the condition of the user shown in FIG. 6, it is apparent from the drawing that the user is in a relatively comfortable position with normal blood flow to all of his or her limbs and with little or no constriction on either of the limbs. Again, the inventor is of the opinion that the user can be suspended in this position for a significant period of time without ill effect while he or she awaits rescue.

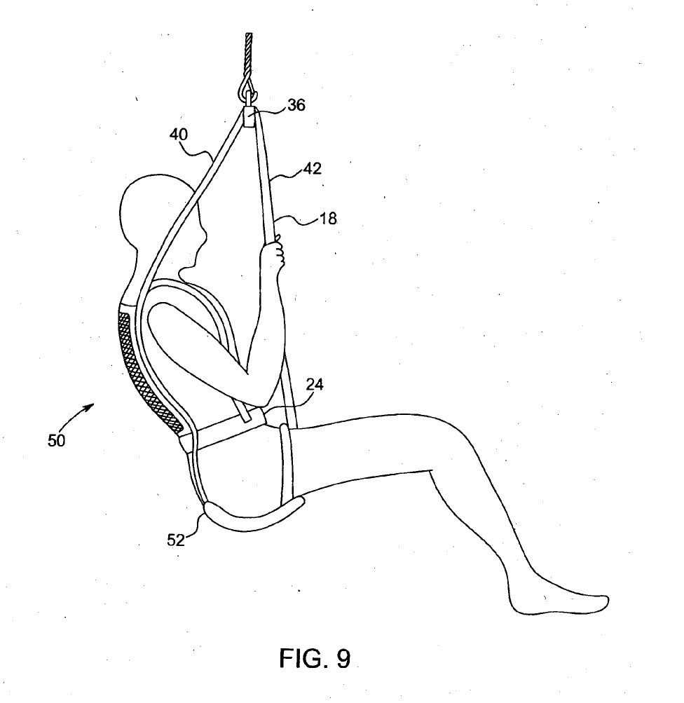

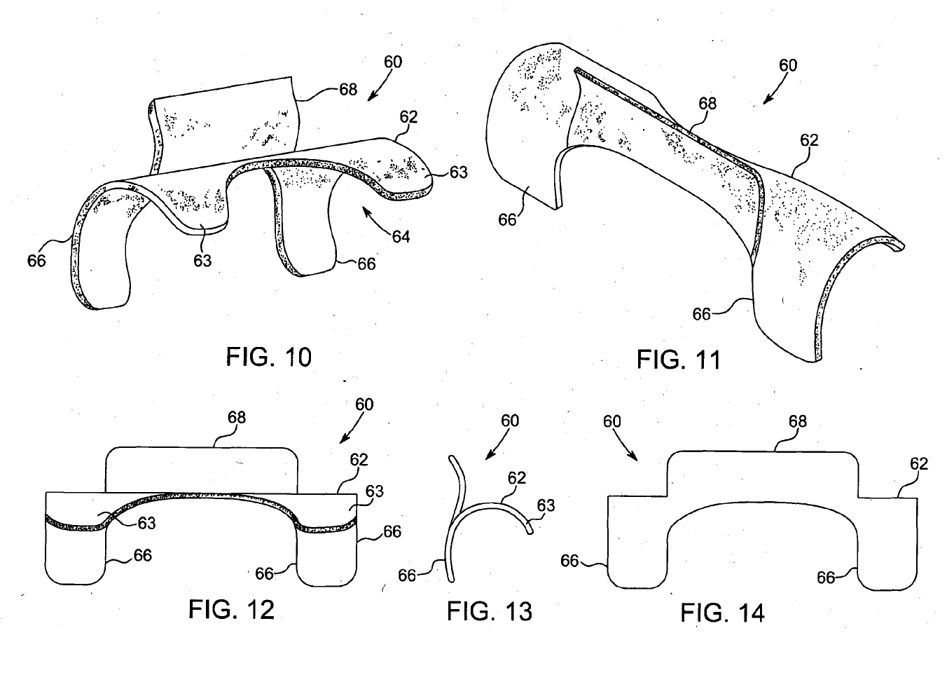

In FIGS. 10 to 14, reference numeral 60 generally indicates a head support member for use with either of the apparatus 10, 50 or any of the further apparatus described below.

The head support member 60 includes a shoulder member 62 that has shoulder tabs 63 that are configured to fit over a user's shoulders. The head support member 60 includes a neck recess 64 to accommodate a user's neck. The shoulder member 62 also defines a pair of spaced back bracing members 66 to stabilise the shoulder member 62.

The head support member 60 includes a neck support 68 extending operatively upwardly from the shoulder member 62.

In use, the head support member 60 can inhibit whiplash which may occur if a user falls back into a recumbent position.

At least the neck support 68 can have a layer of suitable padding.

The head support member 60 can be incorporated or fast with the shoulder straps 20. For example, the shoulder member 62 can be received underneath the shoulder straps 20.

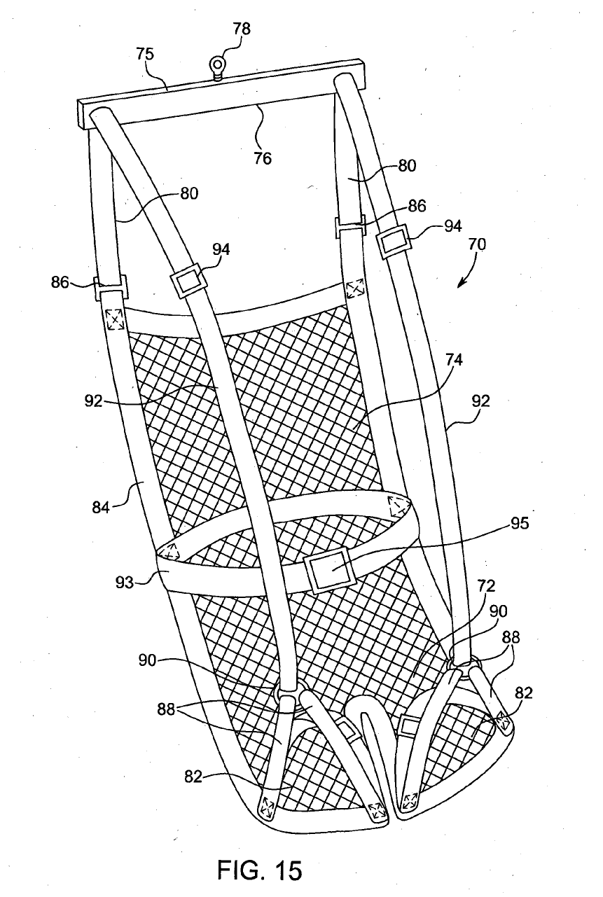

In FIG. 15, reference numeral 70 generally indicates a fall arrest harness, in accordance with the invention, which can be used with existing fall arrest systems or apparatus.

The fall arrest harness 70 includes a support member having a seat portion 72 and a backrest portion 74.

The seat portion 72 and the backrest portion 74 are defined by an element of foraminous material or mesh which is bifurcated at its operatively lower end to define a pair of leg portions 82. The mesh has a border strip 84 of a suitable material such as webbing.

A hanger 75 includes a spreader bar 76 with an eye connector 78 for connecting the spreader bar 76 to a locking snap hook fastener or the like.

Each of a pair of back straps 80 is connected to a respective end of the spreader bar 76 at one end and, at another end, to the backrest portion 74. The spacing of the back straps 80 can accommodate a user's head. Each of the pair of back straps 80 forms part of the border strip 84. Each back strap 80 is adjustable in length by way of a buckle and loop arrangement 86.

A pair of spaced thigh straps 88 is connected to each leg portion 82 to accommodate an upper thigh portion of the user. The thigh straps 88 of each pair are connected to a loop or ring 90.

Each of a pair of front straps 92 is connected to a respective ring 90. Each front strap 92 is adjustable in length by way of a buckle and loop arrangement 94.

A waist strap or belt 93 is fast with the border strip 84 to be received about a user's abdominal area. The belt 93 is adjustable by way of a buckle and loop arrangement 95.

As can be seen in FIG. 15, the seat portion 72 and the backrest portion 74 are suspended, sling-like, from the spreader bar 76. Furthermore, it is to be understood that an angle of recumbency of a user can be adjusted by adjusting the relative lengths of the back and front straps 80, 92.

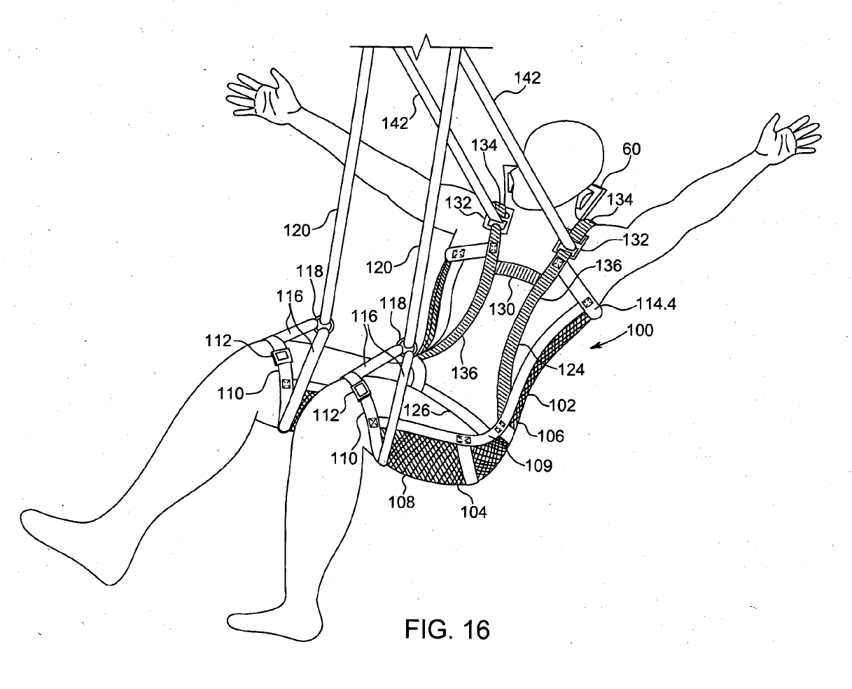

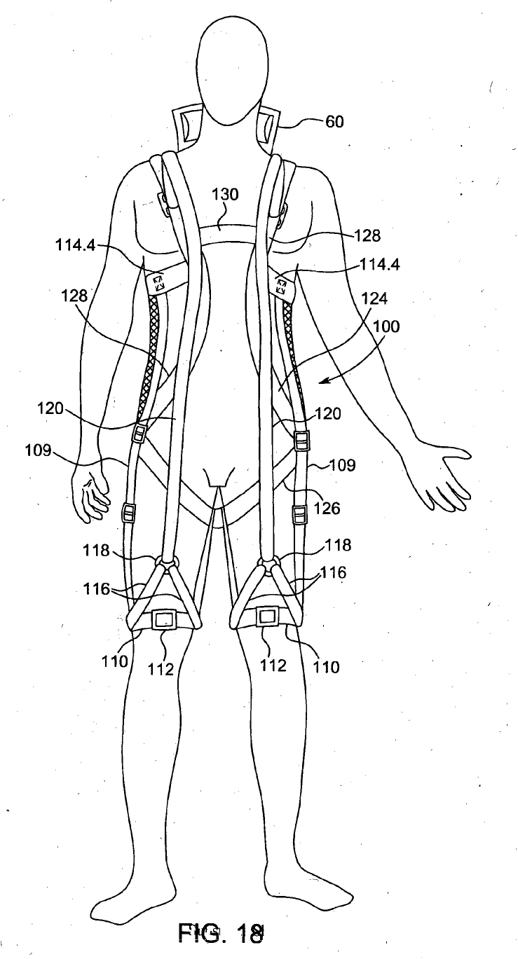

In FIGS. 16 to 18, reference numeral 100 generally indicates an example, in accordance with the invention, of a fall arrest apparatus. With reference to FIGS. 1 to 15, like reference numerals refer to like parts, unless otherwise specified.

In this example, the apparatus 100 includes a fall arrest harness 124 that has a pair of thigh straps 126 for fastening about respective thighs of a user. A body strap 128 extends from one thigh strap 126, over a user's shoulder, diagonally across the user's back to the other thigh strap 126. A chest strap 130 connects the body straps 128 across the user's chest.

The accessory 100 includes a backrest or back support 102 and a seat 104. The back support 102 and the seat 104 are defined by a one-piece structure of foraminous material or mesh 106. The seat 104 is bifurcated to define a pair of leg portions 108 that correspond with a user's thighs. In use, the back support 102 and seat 104 are positioned over the body straps 128 and thigh straps 126.

Perimeter straps 109 are attached to respective sides of the back support 102, seat 104 and leg portion 108. Leg straps 110 are attached to the straps 109 and respective lower ends of the leg portions 108. Each leg strap 110 has an adjustable buckle 112 allowing the leg belt 110 to be fastened to the user's thighs.

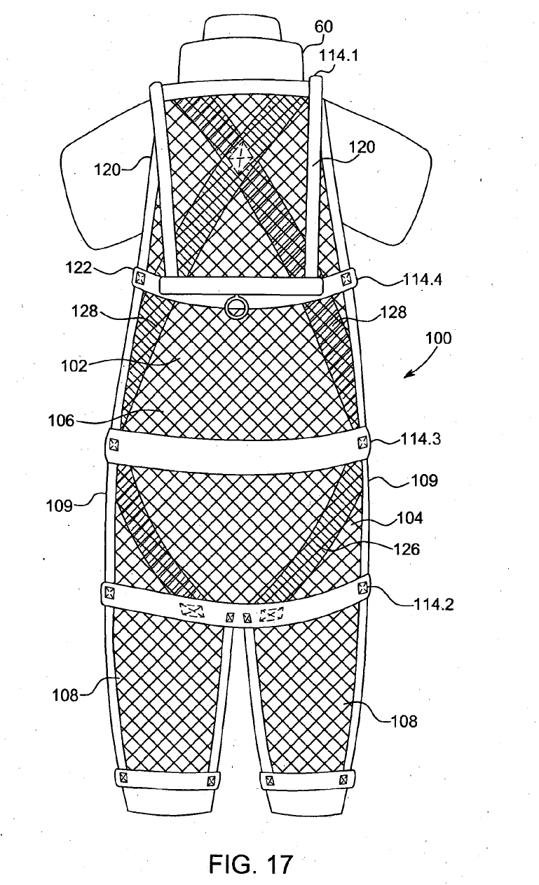

The accessory includes a number of back support straps 114 (FIG. 17) that extend between opposed perimeter straps 109. These are in the form of an upper strap 114.1, a seat strap 114.2, an intermediate strap 114.3 at a waist region and an intermediate strap 114.4 at a thorax region.

A pair of leg support straps 116 (FIG. 16) is connected to each leg strap 110 at one end and to a connecting ring 118 at an opposite end. A leg support strap 120 is connected to each connecting ring 118 at one end and to one end of a spreader bar 122 at an opposite end. The leg support straps 120 can be of a sufficient length to extend over the shoulders of the user when inoperative. Thus, the spreader bar 122 is positioned across the user's back when not in use. For convenience, the front straps 120 and/or the spreader bar 122 can be detachably connected to the back support 102 to be torn away or detached if the user should fall.

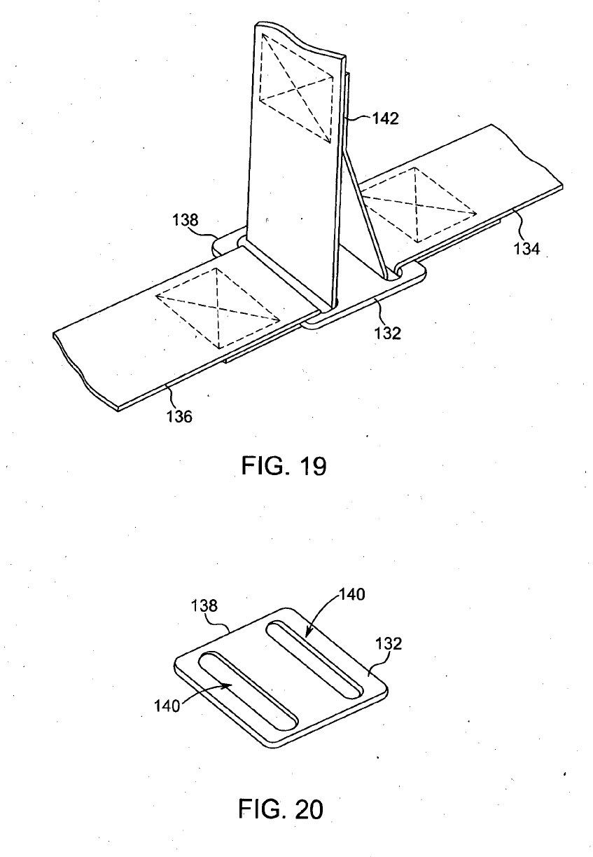

The body straps 128 of the existing harness 124 are divided at front parts to define a back harness strap 134 and a front harness strap 136. The accessory 100 includes a pair of triple belt connectors 132 (shown in detail in FIGS. 19 and 20) that connect each back harness strap 134 to a respective front harness strap 136 (FIG. 16). Each triple belt connector 132 has a body 138 that defines a pair of spaced slots 140. One end of the back harness strap 134 is threaded through one of the slots 140 and stitched back onto itself. One end of the front harness strap 136 is threaded through the other of the slots 140 and stitched back onto itself. The body 138 can have a curved profile to accommodate the user's body and to rest in a comfortable manner over a chest or pectoral region of the user.

A shoulder support strap 142 is connected to each triple belt connector 132. In particular, one end of the shoulder support strap 142 is threaded through both the slots 140 and stitched back onto itself. Opposite ends of the shoulder support strap 142 are fastened to respective ends of the spreader bar 122.

The intermediate strap 114.4 extends beyond the perimeter straps 108 to be fastened to each front harness strap 136.

In this embodiment, the head support member 60 is shown fast with the upper strap 114.1.

As before, the straps can be of webbing woven from any suitable material such as that used for high-level activities such as mountaineering and rescue work. The mesh may be of a similar material.

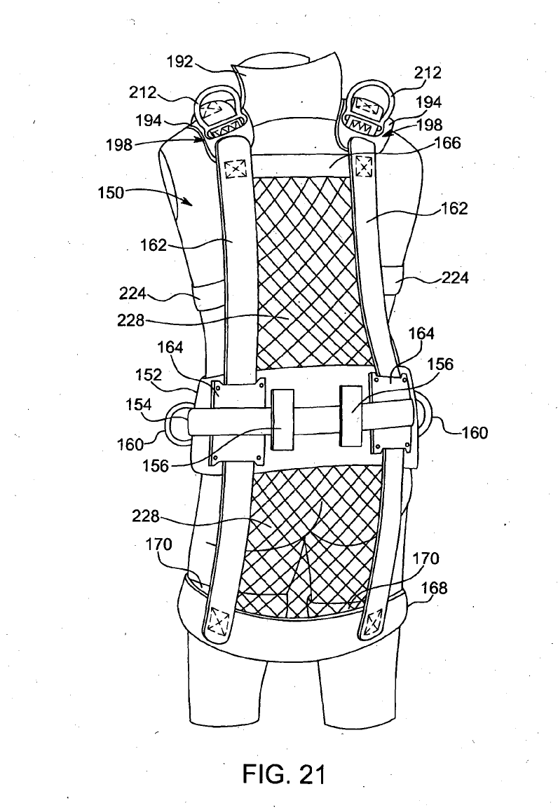

In FIGS. 21, 22 and 27, reference numeral 150 generally indicates another embodiment of a fall arrest apparatus, in accordance with the invention. With reference to the preceding drawings, like reference numerals refer to like parts, unless otherwise specified.

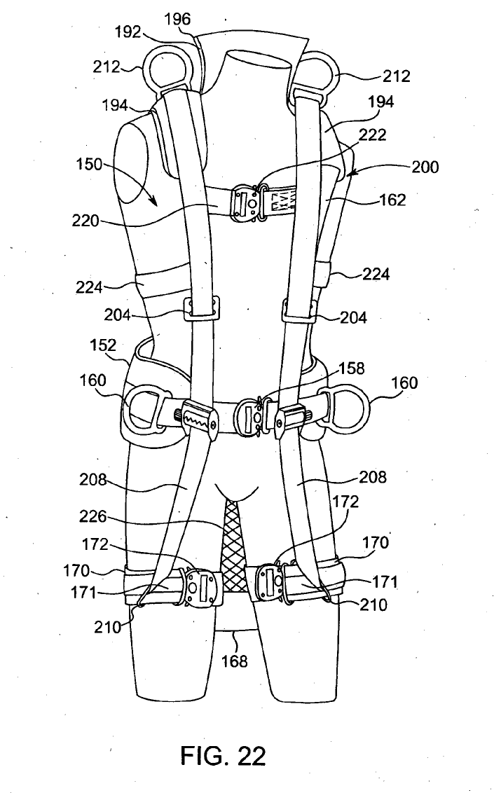

The apparatus 150 includes a waist support or band 152. A belt 154 is received over the waist band 152 and passes through a pair of loops 156 attached to the band 152. The belt 154 is fastened with a quick-release, adjustable buckle 158 (FIG. 22). A pair of D-rings 160 is arranged on the belt 154.

A pair of back straps 162 is received through respective sleeves 164 that are attached to the band 152. The back straps 162 are positioned and dimensioned to extend from a region between the knees and the buttocks of the user over a shoulder region of the user. A top strap 166 is interposed between and fastened between the straps 162 at the shoulder region.

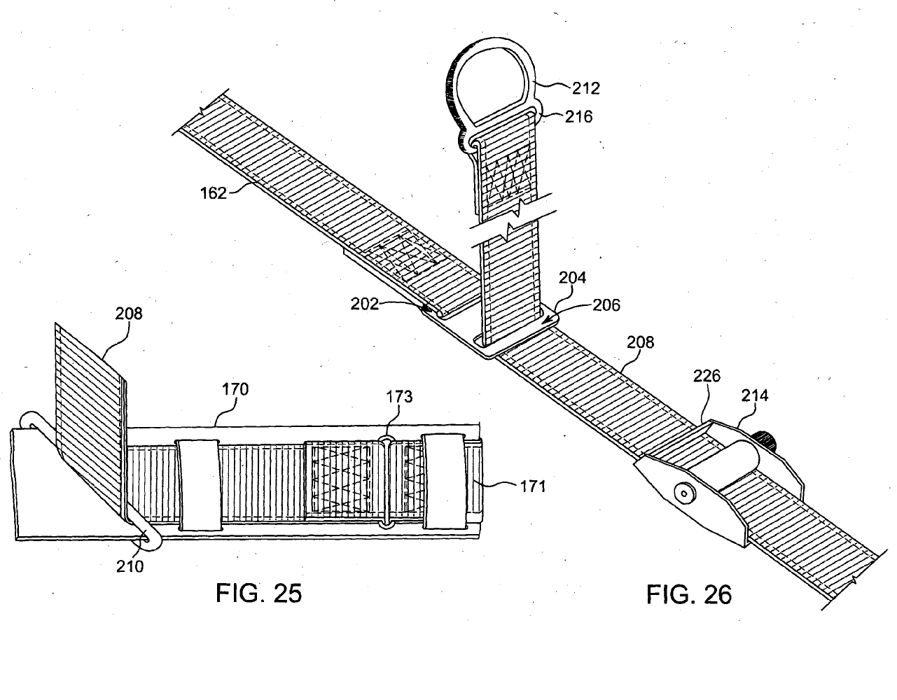

Lower portions of the back straps 162 are fastened to a thigh support or band 168 that is configured to extend across rear thigh portions of the user. Leg bands 170 are fastened to the band 168 and are configured to be fastened about respective thighs of the user. Each leg band 170 includes a strap 171 that is fastened to and extends about the leg band 170. At one end of each band 170, one end of the strap 171 is threaded through a loop 173 and fastened back onto itself with stitching, for example. Further detail of this can be seen in FIGS. 25 and 31. One part of a quick-release, adjustable buckle 172 is fastened to that end of the band 170 while another part is fastened to opposite ends of the strap 171 and the band 170 so that the leg bands 170 can be adjusted to suit the user.

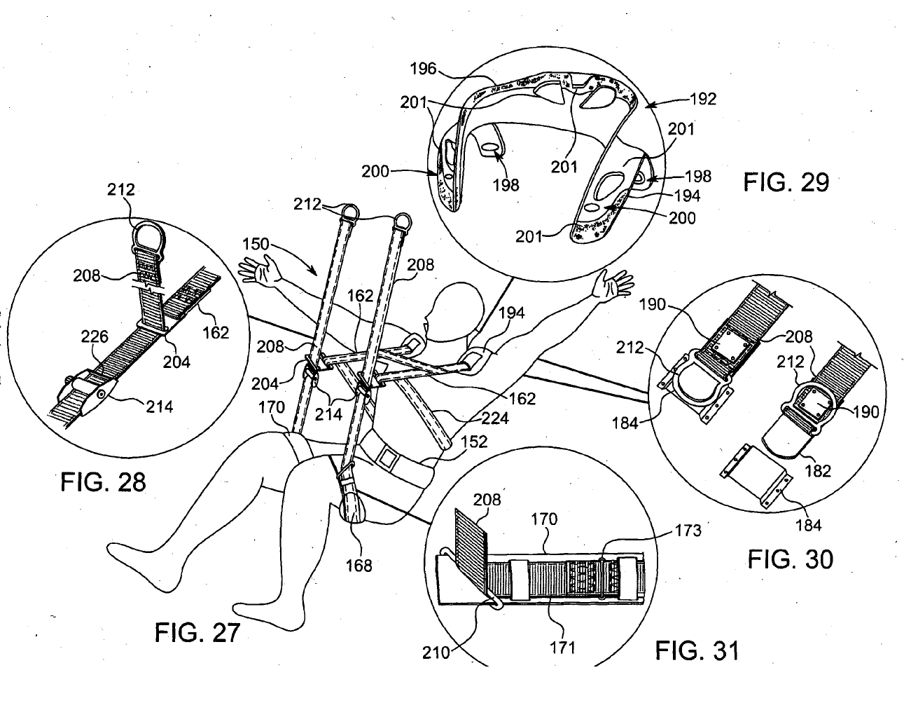

The apparatus 150 includes a neck brace 192 detail of which is shown in FIG. 29. The neck brace 192 has shoulder members 194 shaped so that the brace 192 can fit over the user's shoulders. A neck support member 196 is interposed between the shoulder members 194 and is shaped to cradle the user's neck. Each shoulder member 194 defines a back opening or slot 198 and a front opening or slot 200. Padding 201 is arranged on front edges of the shoulder members 194 and on an edge of the neck support member 196 for comfort and safety. The neck brace 192 defines further openings 201 for aesthetic and ventilation purposes.

The back straps 162 are threaded under respective shoulder members 194, through respective back slots 198 and over and under respective shoulder members 194 through respective front slots 200.

Ends of the back straps 162 are threaded through slots 202 defined by connectors 204 that have one further slot 206 and are fastened back on themselves, by stitching, for example. Detail of each connector 204 can be seen in FIG. 26.

The apparatus 150 includes two support straps 208. One end of each support strap 208 is connected to a respective leg band 170, in the manner shown in FIG. 25. Each leg band 170 is received through a loop 210 that is oriented at roughly 45 degrees with respect to the leg band 170. Each support strap 208 passes through the loop 210 and is threaded through the loop 173 and fastened back on itself with stitching, for example.

Each support strap 208 is received through a length adjustment mechanism in the form of a tensioner 214 and the slot 206 in the connector 204. Thus, the tensioner 214 is interposed between the connector 204 and the loop 210. An end of each support strap 208 is received through a loop 216 of a D-ring 218 for connection to a safety support system. The end can be fastened back onto itself by stitching, for example.

A chest strap 220 connects the back straps 162 across the user's chest area and includes a quick-release buckle 222. The chest strap 220 is adjustable to suit different users.

The apparatus 150 includes a pair of side straps 224. One end of each side strap 224 is connected to a respective back strap 162 in the user's rear thorax area. An opposite end of each side strap 224 is connected to a respective back strap 162 in the user's chest area.

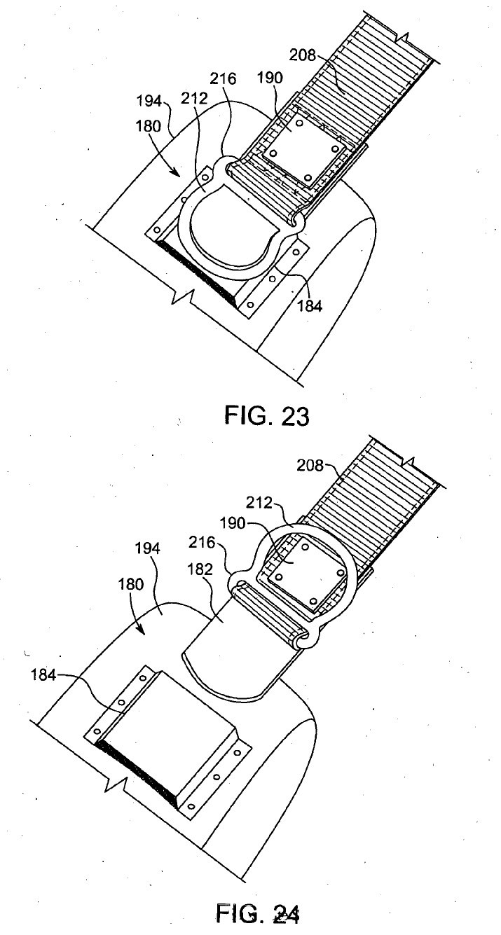

The support straps 208 are capable of being positioned in a stowed condition ready for deployment. This is achieved by tongue and slot mechanisms 180 (FIGS. 23, 24 and 30). Each mechanism 180 has a slot member 184 mounted on a back portion of each shoulder member 194. A tongue member or tongue 182 is fast with an end of each strap 178.

For example, the tongue 182 can be riveted or screwed to a plate 190 with fasteners extending between the tongue 182 and the plate 190 through overlapping portions of the support strap 208 between which the D-ring 218 is secured as described above. Thus, the tongue and slot mechanisms 180 can be of steel. The plate 190 can configured and positioned to protect the strap 178 from damage when the safety support system is attached to and released from the rings 188.

One of the tongue and slot mechanisms 180 is shown in a stowed condition in FIG. 23 and a pre-deployment condition in FIG. 24.

When the apparatus 150 is deployed, the support straps 208 move towards a vertical orientation (FIG. 27), pulling the user's thighs towards a horizontal orientation. At the same time, the back straps 162 are pulled towards a horizontal orientation with movement of the connectors 204 with respect to the user's thighs until the connectors 204 strike the tensioners 214. For that purpose, the tensioners 214 have strike plates 226 to absorb the impact. It will be appreciated that the position of the tensioners 214 determines the extent of recumbency of the user. For example, if the tensioners 214 are tensioned to shorten a length of the support straps between the tensioners 214 and the leg bands 170, recumbency of the user is increased, while loosening of the tensioners results in a reduction of recumbency.

Thus, the tongue and slot mechanisms 180 can be configured so that the tongues 182 can be retained in the slot members 184 while the user is carrying out normal tasks, but can be released when the user falls.

The various straps of the apparatus and harness 10, 50, 70, 100, 150 are of a woven, high strength material, such as webbing. Examples of suitable material are nylon, polypropylene or polyester. Where necessary, the webbing can be woven of Dyneema or Kevlar if further strength is required. The foraminous material or mesh can be formed form string or cords woven with such material.

A foraminous material or mesh 228 is secured between the back straps 162 to overlie the back and seat areas of the user.

The inventor submits that the apparatus and harness 10, 50, 70, 100 and 150 all serve to reduce injuries that may occur with existing safety harnesses. The reason for this is that the apparatus automatically places the user in a recumbent position with little or no constriction of the limbs. It follows that an injured worker can be safely transitioned or transferred to an ambulance gurney or stretcher. Furthermore, should the user become unconscious while falling, for example, by being struck on the head, the fact that the apparatus is deployed automatically and the head is supported means that the user is protected from further injury.

Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:

a. there is no requirement for the inclusion of any particular described or illustrated characteristic, function, activity, or element, any particular sequence of activities, or any particular interrelationship of elements;

b. any elements can be integrated, segregated, and/or duplicated;

c. any activity can be repeated, any activity can be performed by multiple entities, and/or any activity can be performed in multiple jurisdictions; and

d. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It is to be understood that the terminology employed above is for the purpose of description and should not be regarded as limiting. The described embodiments are intended to be illustrative of the invention, without limiting the scope thereof. The invention is capable of being practiced with various modifications and additions as will readily occur to those skilled in the art.

1. A fall arrest apparatus that comprises
a body harness having a backrest and a seat and capable of being worn by a user so that the backrest extends from a rear shoulder region to a rear hip region of the user while the seat extends from about the rear hip region to a rear thigh region of the user; and
a suspension harness configured for connection to the body harness at a front shoulder region and at a front thigh region, such that when the user is suspended from the suspension harness in the body harness, the user is reclined in the body harness with a weight of the user being distributed across the backrest and seat assemblies.

2. A fall arrest apparatus as claimed in claim 1, in which the body harness includes a waist band for securing about a user's waist and a buckle so that the waist band can be secured to and released from a user.

3. A fall arrest apparatus as claimed in claim 2, in which the backrest and seat include a pair of back straps arranged on the waist band, the back straps being configured to extend from a region between knees and buttocks of the user over the shoulders of the user.

4. A fall arrest apparatus as claimed in claim 3, in which the seat includes a thigh support that is configured to extend across rear thigh portions of the user.

5. A fall arrest apparatus as claimed in claim 4, in which operatively lower ends of the back straps are fastened to the thigh band and leg bands are fastened to the thigh band and are configured to be fastened about respective legs of the user.

6. A fall arrest apparatus as claimed in claim 5, in which connectors are fastened to respective operatively upper ends of the back straps, the connectors each defining a pair of slots, one for attachment of the associated back strap and the other for receiving a further strap.

7. A fall arrest apparatus as claimed in claim 6, which includes two support straps connected at one end to respective leg bands, each support strap being received through a length adjustment mechanism and through a respective slot of the connectors so that the support straps can slide with respect to the connectors, the extent of sliding being limited by a position of the adjustment mechanisms such that adjustment of the adjustment mechanisms can be used to adjust a recumbency of the user when the apparatus is deployed.

8. A fall arrest apparatus as claimed in claim 7, in which connecting members are fastened to respective opposite ends of the support straps for connection to a safety support system.

9. A fall arrest apparatus as claimed in claim 8, which includes an attachment mechanism for attaching the support straps to a suitable part of the apparatus in a stowed condition while remaining connected to the safety support system, the attachment mechanism being configured to release the support straps if the user falls.

10. A fall arrest apparatus as claimed in claim 3, which includes a neck brace, the neck brace having shoulder members that are shaped so that the neck brace can fit over the user's shoulders and a neck support member that is interposed between the shoulder members and shaped to cradle the user's neck.

11. A fall arrest apparatus as claimed in claim 10, in which the back straps are threaded through respective shoulder members.

12. A fall arrest apparatus as claimed in claim 10, in which ends of the support straps and the neck brace may have complementary attachment mechanisms so that the ends can be attached to the neck brace with the connecting members attached to the safety support system, the attachment mechanisms being configured to detach if the user falls.
